(19) United States
(12) Patent Application Publication
(10) Pub. No.: US 2013/0042866 A1
(43) Pub. Date: Feb. 21, 2013

(54) Breathing Air Unit

(71) Applicant: Øyvind Næss Johannessen, Rennesoy (NO)

(72) Inventor: Øyvind Næss Johannessen, Rennesoy (NO)

(21) Appl. No.: 13/513,116

(22) PCT Filed: Dec. 2, 2010
(86) PCT No.: PCT/NO2010/000441

§ 371 Date: Jul. 24, 2012

(30) Foreign Application Priority Data
Dec. 9, 2009 (NO) 20093496

(51) Int. Cl. A62B 7/00

(52) U.S. Cl. 128/204.15

(57) ABSTRACT

This invention relates to a breathing air unit comprising an electric motor for driving a compressor. Compressed air is conducted through a first heat exchanger cooled by cooling air of the compressor, and the compressed air is conducted through a second heat exchanger being cooled by cooling air of the motor.

This invention concerns a breathing air unit. More particularly, the invention relates to a breathing air unit comprising a motor for driving a compressor, wherein compressed air is conducted through a first heat exchanger cooled by cooling air from the compressor.

Relatively strict authority requirements have been stipulated with respect to the quality of compressed air to be used as breathing air. With oil as a lubricant in a compressor chamber and as a coolant for other mechanical components in a compressor, there will always be a risk of getting oil vapour into the compressed air. The air from compressors of this type is therefore unsuitable as breathing air if not subjected to extensive filtering.

According to prior art, so-called oil-free compressors, normally in the form of piston compressors and certain screw compressors, are used for delivering breathing air. The oil-free compressor may form a part of a unit for delivering breathing air. Units of this is type are oftentimes of such a size that they resemble stationary installations.

During work on large constructions with significant distances involved, a need for relatively long pipe- and hose connections arises, which is labour-intensive and must be viewed in context of surrounding work with respect to the danger of breaks in the hose connections. Frequently these hose connections cause condensation and bacterial problems in the breathing air, hence result in an uncertain supply of breathing air to the user.

Moreover, examples of prior art within the area of breathing air units may be found in DE 4344353 A1 and JP 8010331 A.

DE 4344353 A1 discloses a portable breathing air unit, wherein the breathing air is cooled by means of a single heat exchanger. This heat exchanger is not cooled by means of the cooling fan of the motor or the cooling fan of the compressor.

JP 8010331 A concerns a breathing apparatus for medical use, wherein a scroll compressor is used in the breathing apparatus.

The object of the invention is to remedy or reduce at least one of the disadvantages of the prior art.

The object is achieved in accordance with the invention and by virtue of the features disclosed in the following description and in the subsequent claims.

A breathing air unit comprising an electric motor for driving a compressor is provided, wherein compressed air is conducted through a first heat exchanger cooled by cooling air from the compressor. The breathing air unit is characterized in that the compressed air is conducted through a second heat exchanger cooled by cooling air from the motor.

The compressor may be comprised of a scroll compressor.

A scroll compressor frequently comprises two snail-shaped laminas/ribs, which are working against each other, and which are structured for oil-free delivery of pressurized air. Generally, the delivery of pressurized air is free of any pulsing. However, compressors of this type deliver pressurized air at a relatively high temperature. Accordingly, the general view in this field of expertise is that scroll compressors are unsuitable for delivering breathing air unless external elements are provided in order to cool the compressed air.

Advantageously, however, the scroll compressor is compact, as compared to oil-free piston compressors, with respect to the delivered amount of air. The inventor has succeeded in building a wheel-going, compact breathing air unit capable of being wheeled, by hand, onto the user location.

According to the invention, the superfluous heat is removed from the compressed air by virtue of conducting the compressed air through the second heat exchanger, which is cooled by cooling air of the motor. Advantageously, the motor's own cooling fan may be used for the purpose, but a separate fan may also be used. This technical solution contributes further to allowing a breathing air unit according to the invention to be provided in a relatively compact and lightweight design.

The second heat exchanger may be located upstream of the motor. By so doing, it is avoided that the cooling air is heated by the motor before the cooling air passes through the second heat exchanger.

The compressed air may be conducted, in a manner known per se, through conventional filters in order to satisfy current requirements with respect to purity and quality of breathing air.

The cooling air of the motor normally discharges from the motor in a known manner. In an alternative embodiment, the cooling air from the motor may be conducted through the first heat exchanger as an addition to the cooling air of the compressor.

The unit according to the invention renders possible to build a compact and relatively simple breathing air unit capable of easily being wheeled onto the user location.

Hereinafter, an example of a preferred embodiment is described and depicted in the accompanying drawings, wherein:

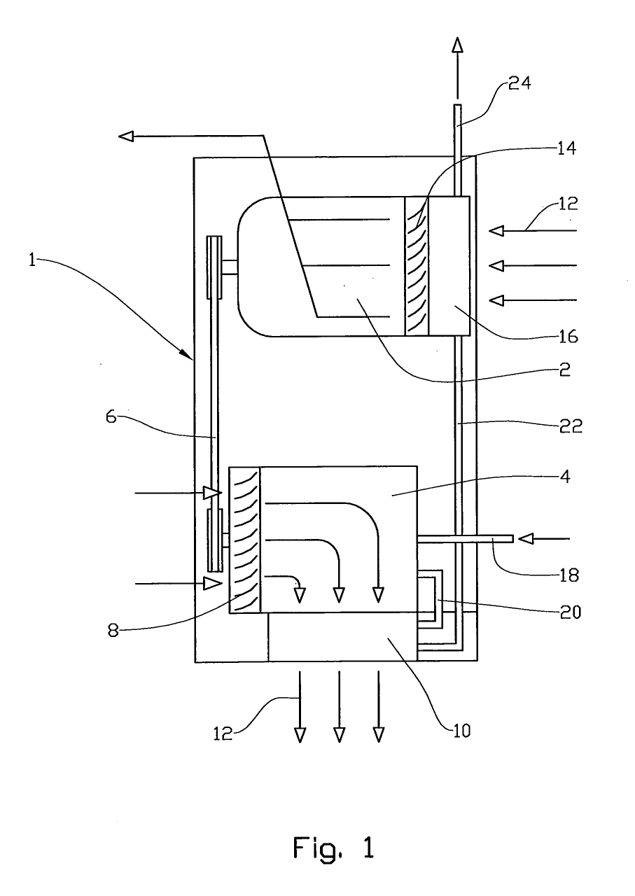

FIG. 1 shows a principle sketch of a breathing air unit according to the invention; and

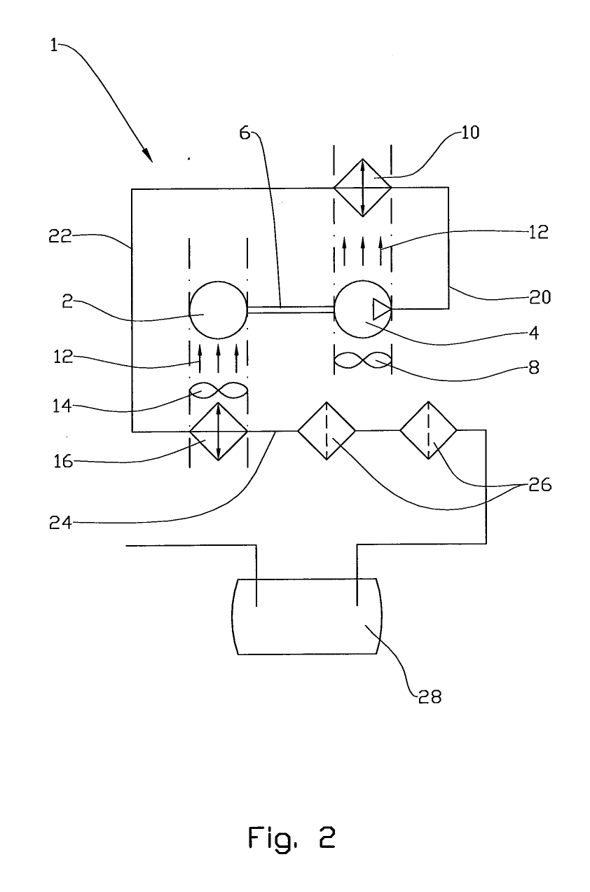

FIG. 2 shows a symbol diagram for the breathing air unit in FIG. 1.

In the drawings, reference numeral 1 denotes a breathing air unit comprising an electric motor 2 and a compressor 4. The motor 2 drives the compressor 4 via a V-belt transmission 6.

The compressor 4, which in this preferred embodiment is a scroll compressor, is provided with a compressor fan 8. The compressor fan 8 is arranged in a manner allowing it to cause cooling air to flow through the compressor 4 when the compressor 4 is operating. The compressor fan 8 also causes the cooling air to flow through a first heat exchanger 10.

Arrows 12 in the figures show flow directions. Cooling air flowing internally in the compressor housing and across the compressor 4 has only been insignificantly heated when flowing into the first heat exchanger 10.

The motor 2 is provided with a motor fan 14 drawing cooling air into the motor 2 via an upstream second heat exchanger 16, the motor fan 14 being arranged in a manner allowing it to blow cooling air across the motor 2. The second heat exchanger 16 is connected in a sealing manner to the motor fan 14 in such a way that all air flowing through the motor fan 14 also must flow through the second heat exchanger 16.

The uncompressed air, which is comprised of pre-filtered, ambient air, flows into the compressor 4 via an air inlet 18. The compressed air flows from the compressor 4 via a compressor pipe 20 and onto the first heat exchanger 10, and then onto the second heat exchanger 16 via an intermediate pipe 22. The compressed air flows from the second heat exchanger 16 via an outlet pipe 24 and onto, respectively, a water separator 26, a pressure vessel 28 and onwards via filters (not shown) and valves (not s shown) onto a user (not shown); se FIG. 2.

Thus, the air compressed in the compressor 4 becomes cooled by means of the compressor cooling air in the first heat exchanger 10, and then by the motor cooling air in the second heat exchanger 16.

By so doing, the compressed air is cooled to a comfortable user temperature before reaching the user (not shown), and without having to pass through long hose- or pipe connections capable of causing condensation and bacterial problems.

1. A breathing air unit (1), said unit comprising:
an electric motor (2) for driving a compressor (4), wherein compressed air is conducted through a first heat exchanger (10) cooled by cooling air of the compressor (4), the compressed air being conducted through a second heat exchanger (16) cooled by cooling air of the motor (2).

2. The breathing air unit (1) according to claim 1, wherein the compressor (4) is comprised of a scroll compressor.

3. The breathing air unit (1) according to claim 1, wherein the second heat exchanger (16) is located upstream of the motor (2).
